(19) United States
(12) Patent Application Publication
(10) Pub. No.: US 2015/0370781 A1
(43) Pub. Date: Dec. 24, 2015

(54) EXTENDED-CONTEXT-DIVERSE REPEATS

(71) Applicant: Xerox Corporation, Norwalk, CT (US)

(72) Inventor: Matthias GALLÉ, Saint Martin d'Heres (FR)

(21) Appl. No.: 14/311,993

(22) Filed: Jun. 23, 2014

(51) Int. Cl. G06F 17/27

(52) U.S. Cl. CPC G06F 17/2765

(57) ABSTRACT

A method for identifying repeat subsequences based a diversity of on their extended contexts includes identifying repeat subsequences of symbols in a sequence that are left and/or right maximal and which have at least a threshold value of different left and/or right contexts. The different right contexts are all right-maximal repeats with respect to subsequences of the symbols that immediately follow an occurrence of the respective repeat subsequence and similarly, the different left contexts are all left-maximal repeats with respect to subsequences of the symbols that immediately precede an occurrence of the respective repeat subsequence. This class of repeat subsequences, referred to as extended-context diverse repeats, since the contexts are not limited to a single symbol, can be output or used for characterizing the sequence or a collection of sequences, such as a document or collection of documents.

### BACKGROUND

The exemplary embodiment relates to systems and methods for identifying repeat subsequences in a sequence of symbols based on their surrounding context, and finds application in representing a textual document using identified repeat subsequences for interpretation of documents, such as classifying the textual document or for comparing or clustering of documents.

Inferring constituents, such as a set of repeated words or sequences of words, is a basic step for many applications involving textual documents. These are the semantic blocks that define the meaning of a document. They can be used to represent the document, and an accurate description of a document is beneficial to tasks such as classification, clustering, topic detection, and knowledge extraction. They are also useful in inferring the structure of a document. In grammatical inference, where it is assumed that the document samples are generated by a grammar, it is also useful to determine which sequences of the document correspond to the same grammatical constituent before detecting how different rules are related to each other.

The standard approach for extracting features and creating representations for textual documents is called the “bag-of-words,” where each dimension in a vector space model represents one word. To consider longer sequences, higher level language models, such as n-grams, may be used. One drawback of this approach is that it is not readily scalable to larger and non-static document collections.

Application Ser. No. 13/765,066 describes a bag-of-repeats approach that uses larger sequences to model documents. Application Ser. No. 13/901,736 describes a method for detection of meaningful constituents by considering the context in which a word appears and not only its frequency or length. Two classes of repeats, maximal and largest-maximal repeats were introduced. A property of these classes is that they have at least two different contexts (maximal repeats) or at least one unique context (largest-maximal repeats). In both cases, the context of an occurrence of a word is defined as the pair of symbols appearing immediately to the left and to the right of that occurrence. This ignores useful information which could be derived from more distant relationships.

There remains a need for a system and method for detection repeats in a document collection which considers not only the immediate context of an occurrence.

### INCORPORATION BY REFERENCE

The following references, the disclosures of which are incorporated herein in their entireties by reference, are mentioned:

U.S. application Ser. No. 13/765,066, filed on Feb. 12, 2013, entitled BAG-OF-REPEATS REPRESENTATION OF DOCUMENTS, by Matthias Gallé. describes a system and method for representing a document based on repeat subsequences.

U.S. application Ser. No. 13/901,736, filed May 24, 2013, entitled IDENTIFYING REPEAT SUBSEQUENCES BY LEFT AND RIGHT CONTEXTS, by Matthias Galle describes a method of identifying repeat subsequences of symbols that are left and right context diverse.

U.S. application Ser. No. 14/047,099, filed Oct. 7, 2013, entitled INCREMENTAL COMPUTATION OF REPEATS, by Matthias Galle and Matías Tealdi describes a method for computing certain classes of repeats using a suffix tree.

The following relate to training a classifier and classification: U.S. Pub. No. 20110040711, entitled TRAINING A CLASSIFIER BY DIMENSION-WISE EMBEDDING OF TRAINING DATA, by Perronnin, et al.; and U.S. Pub. No. 20110103682, entitled MULTI-MODALITY CLASSIFICATION FOR ONE-CLASS CLASSIFICATION IN SOCIAL NETWORKS, by Chidlovskii, et al.

The following relates to a bag-of-words format: U.S. Pub. No. 20070239745, entitled HIERARCHICAL CLUSTERING WITH REAL-TIME UPDATING, by Guerraz, et al.

### BRIEF DESCRIPTION

In accordance with one aspect of the exemplary embodiment, a method includes receiving a sequence of symbols, the symbols being drawn from an alphabet. Provision is made for identifying repeat subsequences of the symbols in the sequence. Each of the identified repeat subsequences is a repeat subsequence which is at least one of left-maximal and right-maximal in the sequence. Each identified repeat subsequence has at least one of: a) at least one different right context in the sequence, each of the at least one different right contexts comprising a respective different subsequence of the symbols in the sequence which immediately follows an occurrence of the repeat subsequence in the sequence, each of the different right contexts being a right-maximal repeat with respect only to subsequences of the symbols that immediately follow an occurrence of the respective repeat subsequence, and b) at least one different left context in the sequence, each of the at least one different left contexts comprising a respective different subsequence of the symbols in the sequence which immediately precedes an occurrence of the repeat subsequence in the sequence, each of the different left contexts being a left-maximal repeat with respect only to subsequences of the symbols that immediately precede an occurrence of the respective repeat subsequence. The method further includes outputting at least one of a) at least one of the identified repeat subsequences as an extended-context-diverse repeat subsequence, and b) information based on the identified extended-context-diverse repeat subsequences of symbols.

One or more of the steps of the method may be performed with a processor.

In accordance with another aspect of the exemplary embodiment, a system for identifying extended-context-diverse repeat subsequences includes a suffix sorter which generates at least one lexicographically-sorted arrangement of suffixes from an input sequence of symbols. Each of the at least one arrangement of suffixes represents a suffix tree in which a root representing the input sequence is connected to nodes representing subsequences of the input sequence, some of the nodes being internal nodes which space others of the nodes from the root. A repeat subsequence detector receives the arrangement of suffixes and receives at least one of a threshold value for different left contexts for a given repeat subsequence in the sequence and a threshold value for different right contexts for a given repeat subsequence in the sequence. The repeat subsequence detector identifies repeat subsequences in the sequence based on the at least one arrangement of suffixes, each of the identified repeat subsequences corresponding to an internal node in the suffix tree which has at least one descendant that is also an internal node. For each identified repeat subsequence, the detector compares a count of the descendants that are internal nodes with the at least one of the threshold values and identifies, as extended-context-diverse repeat subsequences, identified repeat subsequences for which the count of the descendants that are internal nodes meets the at least one of the threshold values. A processor implements the suffix sorter and the repeat subsequence detector.

In accordance with another aspect of the exemplary embodiment, a method for representing a document includes receiving a collection of documents, generating a sequence of symbols in an alphabet based on text of at least some of the documents in the collection, and defining a threshold value for at least one of: a) different right contexts for a given repeat subsequence in the sequence, each of the different right contexts comprising a respective different subsequence of the symbols in the sequence which immediately follows an occurrence of the repeat subsequence in the sequence, each of the different right contexts being a right-maximal repeat with respect only to subsequences of the symbols that immediately follow an occurrence of the respective repeat subsequence, and b) different left contexts for a given repeat subsequence in the sequence, each of the different left contexts comprising a respective different subsequence of the symbols in the sequence which immediately precedes an occurrence of the repeat subsequence in the sequence, each of the different left contexts being a left-maximal repeat with respect only to subsequences of the symbols that immediately precede an occurrence of the respective repeat subsequence. The sequence is processed to identify repeat subsequences, each including at least one of the symbols, and those of the repeat subsequences in the sequence which have at least one of the threshold value of different left contexts and the threshold value of different right contexts are identified as extended-context-diverse repeat subsequences. For a document in the collection, the document is represented, based on occurrences of repeat subsequences in the document that are among the identified extended-context-diverse repeat subsequences.

One or more of the generating, defining, processing, and representing may be performed by a computer processor.

### BRIEF DESCRIPTION OF THE DRAWINGS

FIG. 1 is a plot illustrating a uniform independent and identically distributed (IID)-generated synthetic sequence of length 10⁴ over an alphabet of 26 where a dot at (X,Y) corresponds to a left, right maximal repeat with X occurrences and Y different right and left contexts;

FIG. 2 is a similar plot using the King James Version of the Bible (using characters as symbols);

FIG. 3 is a functional block diagram of a system for identifying extended-context-diverse repeats in accordance with one aspect of the exemplary embodiment;

FIG. 4 is a flow chart illustrating a method for identifying extended-context-diverse repeats in accordance with another aspect of the exemplary embodiment;

FIG. 5 illustrates a suffix tree for an exemplary sequence, illustrating identification of nodes corresponding to extended-right-context-diverse repeats;

FIG. 6 is a plot illustrating a uniform IID-generated synthetic sequence of length 10⁴ over an alphabet of 26 using extended-context-diverse repeats where a dot at (X,Y) corresponds to an extended-left,right-context-diverse repeat with X occurrences and Y different right and left contexts;

FIG. 7 is a similar plot to FIG. 6, using the King James Version of the Bible (using characters as symbols);

FIG. 8 is a plot illustrating extended-context diversity for a sequence generated from a document collection, in which the symbols are parts-of-speech, where a dot at (X,Y) corresponds to an extended-context-diverse repeat with X occurrences and Y different right and left contexts;

FIG. 9 illustrates precision for the top k repeats, where document ranking k is based on a distance to the fitted line in FIG. 8.

### DETAILED DESCRIPTION

Aspects of the exemplary embodiment relate to a system and method for extracting text constituents in a sequence of symbols based on the analysis of repeats (sub-sequences occurring more than once) and the diversity of the left and/or right context(s) of the repeats. The left and right contexts are considered as being potentially unbounded, i.e., extending beyond the previous (next) symbol in the sequence, potentially up to the beginning or end, respectively, of the sequence. In an exemplary embodiment, the identified extended-left(right)-context-diverse repeats are left(and/or right)-maximal repeats whose left (and/or right) contexts are themselves left (or right)-maximal repeats, but only with respect to the occurrences of the given repeat (i.e., only the left (right) contexts of the given context-diverse repeat are considered in determining if the context is itself a left(right)-maximal repeat, not all occurrences of the subsequence corresponding to the considered context).

The terminology used is defined below. However, as a simple example of a method for identifying extended-right-context diverse repeats, consider the sequence of symbols ABCDABDEABCDBBDE. First, a right-maximal repeat is identified, if any. AB is one right-maximal repeat as it occurs at least twice and cannot be extended to the right without decreasing the number of occurrences of the repeat. Its right contexts are then examined to determine which, if any, are also right-maximal. CD is the only one of the right contexts of AB and which is repeated and which cannot be extended without losing the number of its occurrences as a right context of AB. Thus, AB has an extended-right-context diversity of size 1. If a minimum size on the extended-right-context diversity of greater than 1 is specified, then the repeat AB is not considered an extended-right-context-diverse repeat. CD is also a right maximal repeat, but it has no right contexts that are also right maximal, and thus is not an extended-right context-diverse repeat. D is also right maximal, and has a right context E that is also right maximal, and thus D is also an extended-right-context-diverse repeat of size 1.

While the methods could proceed by simply identifying all maximal repeats and then identifying which of those are extended-right (left)-context diverse repeats, an algorithm is described below which may be used to compute the set of all such repeats under all possible left and/or right contexts (of whatever length), in which time complexity is linear with respect to the input size.

The system and method provide a more powerful discrimination of meaningful constituents, as compared to existing methods, such as those based on n-grams. The advantages are particularly noticeable when the alphabet from which the symbols are drawn is small, such as in the case of genomics or bit-oriented data processing. The identification of the exemplary class of context-diverse repeats has relevance to many application areas, such as document clustering, topic detection, document indexing, and grammar inference.

Before discussing the new class of repeats, which is referred to herein as extended-context-diverse repeats (co-cd repeats), some terminology which is used in their description will be defined, and a description provided of classes of repeats that limit the context of a repeat to one symbol.

A “repeat” or “repeat subsequence,” as used herein, is a subsequence of symbols, the subsequence comprising at least one symbol, and wherein at least two occurrences of the subsequence are present in a sequence of symbols. The exemplary symbols may be drawn from a finite alphabet, which may be a predefined alphabet or may be constructed from a sequence of symbols as the sequence is processed. Examples of symbols include words, single characters, and parts-of-speech (POS). In the exemplary embodiment, a repeat subsequence is one which occurs at least twice in the sequence of symbols being analyzed. However, it is also contemplated that a larger number of occurrences may be defined for a subsequence to be considered as a repeat subsequence, such as 3, 4, 5, or more.

In the case of words as symbols, the finite alphabet may consist of all words in the sequence or in a longer sequence which includes the sequence. As an example, the alphabet may include all words (or at least a subset of the words) found in a document or in a collection of documents. Alternatively, a separate dictionary may be provided as the alphabet. In the alphabet, words can be represented by their root (lemma) form. For example, the words present in a document may each be assigned a symbol corresponding to the lemma form of the word.

In the case of characters as symbols, the finite alphabet can include the set of letters A to Z or may include additional or different characters, such as the set of ASCII characters or a Unicode character set, or a selected subset of ASCII or Unicode characters, such as all characters found in the sequence (e.g., a document) or a longer sequence comprising the sequence (e.g., a collection of documents). The sequence of symbols may thus represent letters of a string. The alphabet may be known before the document is processed (for example, predefined by a character mapping or encoding) or constructed as the document is processed.

In the case of parts-of-speech, the finite alphabet can include parts-of-speech which can be assigned to one or more words of a text sequence, such as noun, verb, adjective, adverb, noun phrase, and the like. The number of different parts of speech which can be assigned is limited by the number which a parser is able to recognize and can be, for example, from 10-40. For example, the words present in a document may each be assigned a symbol corresponding to its likely part-of-speech (as assigned by part-of-speech tagging). Some tokens may be initially assigned more than one part-of-speech, which may later be disambiguated, based on contextual information. The tokens may be tagged with the identified parts-of-speech.

Multiple documents may be combined, for example, by concatenation, to form a sequence which is then processed. In the case of words or POS as symbols, the documents considered are generally textual documents in a natural language, such as English or French, having a grammar. The words represented in the sequence are thus words which are primarily found in a dictionary of one or more languages, or which are proper nouns or named entities which obey the grammar of the language. If multiple documents are combined, a repeat need not be limited to a single document and in general at least some of the repeats have subsequent occurrences in more than one of the documents. Repeats may partially overlap each other. For example if the sequence in the document is represented by the symbols ABCCCCC, then overlapping repeats CCC and CCCC can be found, or in a sequence ACACAC, overlapping repeats of ACA and ACAC can be found.

Each symbol in a considered sequence is considered to have a left context and a right context. The left context for a given occurrence of a repeat subsequence includes a symbol which immediately precedes the occurrence of the repeat subsequence in the considered sequence. The right context for a given occurrence of a repeat subsequence includes a symbol which immediately follows the repeat subsequence in the sequence.

The terms left and right refer to the respective positions in the sequence in the reading order of the sequence (or vice versa). For sequences arranged vertically rather than horizontally, left and right contexts can be considered as top and bottom contexts (or vice versa).

A unitary context is a context (left or right) which consists of exactly one symbol. For example in the sequence of symbols ACABACAC, the first occurrence of the repeat ACA has a left unitary context which can be defined by a unique symbol that is not found in the document collection (since there is no actual left context in this case) and a right unitary context which is the symbol B. The second occurrence of the repeat ACA has a left unitary context which is the symbol B and a right unitary context which is the symbol C. Unitary left (right) contexts are thus exactly one symbol in length.

In the exemplary embodiment described herein, the left and right contexts are extended to include symbols which are more distant from the subsequence of interest (which may be referred to herein as “extended contexts” to distinguish them from “unitary contexts,” which are limited to a size of one symbol).

The following notation will be used:

A sequence (or string) s is a concatenation of atomic symbols s[1] . . . s[n] with s[i]∈Σ, i.e., in which each symbol is a member of an alphabet Σ. The length of s, denoted |s| the number of symbols, generally denoted by n.

For ease of computation, it may be assumed that sequence s starts and ends with different unique symbols that are not part of the alphabet Σ (i.e., s[0]=§₁; s[n+1]=§₂; where §₁≠§₂ and §₁, §₂ ∉Σ). The sequence of symbols ACABACAC is thus treated as a sequence §₁ACABACAC§₂.

A subsequence of symbols ω (sometimes referred to herein as a word) is said to occur in s at position k if ω[i]=s[k+i] for i=1 . . . |ω|. ω∈Σ*, i.e., each symbol in subsequence ω is a member of an alphabet that is composed of alphabet Σ plus unique symbols §₁ and §₂. The set of occurrences of subsequence ω in s is denoted by occₛ(ω) (or just occ(ω) if s is clear from the context). If the number of occurrences of the subsequence is greater than 1 (i.e., |occₛ(ω)|≧2), then ω is called a repeat in s.

### Unitary Context Diverse Repeats

The size (cardinality) ulcₛ(ω) of the unitary left context (unitary right context urcₛ(ω)) of a subsequence ω∈Σ* in s may be defined as the number of different symbols appearing immediately to the left (right) over all occurrences of ω:

ulcₛ(ω)=|{s[i−1]:i∈occ(ω)}| and

urcₛ(ω)=|{s[i+|ω|]:i∈occ(ω)}|

As an example, consider the characters in the word bananas as a sequence s of symbols. a is a repeat subsequence ω in bananas because it occurs at least twice. The unitary left context ulc of the subsequence a in the word bananas has a cardinality (or size) ulcₛ(ω) of 2. This is because two different characters appear to the left of the occurrences of a, which are b and n. The size of the unitary right context urcₛ(ω) of a is also 2, and the corresponding characters are n and s.

Repeats can be characterized by the number (size) of their different contexts. A maximal repeat is defined as a repeat co which cannot be extended without losing support (number of occurrences). That is, there is no subsequence aω (and/or ωa) that appears the same number of times as ω. Equivalently, this means that the size of both its right (and/or left) contexts have to be greater than 1. In the above notation:

A repeat ω is a right-maximal repeat if and only if its number of different right contexts is at least 2 (rcₛ(ω)≧2),

A repeat ω is a left-maximal repeat if and only if its number of different left contexts is at least 2 (lcₛ(ω)≧2), and

A repeat ω is left, right maximal repeat in s if and only if its number of different right contexts is at least 2 and its number of different left contexts is at least 2 lcₛ(ω), rcₛ(ω)≧2, referred to herein as a [symbol] 2,2 [symbol] context-diverse repeat.

In the above bananas example, a is a unitary left, right maximal repeat (both unitary contexts have a size of 2). As a counter example, n is a repeat but is not a unitary left, right maximal repeat since the unitary right and left contexts of n are both 1 in size. This implies that it is possible to extend the subsequence without reducing the number of its occurrences. Specifically, the subsequences an, na, and ana all repeat twice (the same number of times as n) and are longer than n. Note that in this simplified example, both the left and right contexts are 1 in size, but the unitary contexts need not both be 1. For example, in the word bandana, the size of the unitary left context of n is 1 and the size of the unitary right context is 2. The subsequence n can still be extended to a longer subsequence an while maintaining the same number of repeats.

A left and right context diverse (LRCD) repeat is defined by the size of its left and right contexts. A subsequence ω is x-left context diverse if its left context size is at least x. A subsequence ω is y-right context diverse if its right context size is at least y. x and y are predefined and can each be equal to or greater than 1 or equal to or greater than 2. More formally:
A subsequence ω is x-left-context-diverse (x−lcd) in s if lc(ω)≧x.
A subsequence ω is y-right-context-diverse (y-rcd) in s if rc(ω)≧y.
A subsequence ω is an [symbol] x, y [symbol] -context diverse in s if it is both x-lcd and y-rcd, i.e., if lc(ω)≧x and rc(ω)≧y.

It may be noted from the above definitions that:
1. A word ω is a left, right maximal repeat in s if and only if it is [symbol] 2,2 [symbol] -context-diverse.
2. A word ω is a super-maximal repeat in s if and only if it is an [symbol] |occ(ω)|, |occ(ω)| [symbol] -context-diverse repeat.
3. A repeat having a cardinality of at least x for its left context and at least y for its right context is an [symbol] x,y [symbol] -context diverse (lrcd) repeat, where x and y are both integers which can be the same or different.

### Extended-Context-Diverse Repeats (∞-cd Repeats)

In the above-defined unitary-context-diverse repeats, fixing the length of the context of a subsequence ω to be exactly 1 symbol allows for efficient algorithms to be used to identify these classes of repeats. However, it introduces a constraint which has no direct semantic interpretation. Consider, for example, a travel corpus with several occurrences of Bob travels to [CITY]. If all city names in these documents start the same (with New, for instance), then travels to would have a unitary right context of size 1, ignoring that New itself is not a constituent but only part of one, such as in New York, New England, New Zealand, etc.

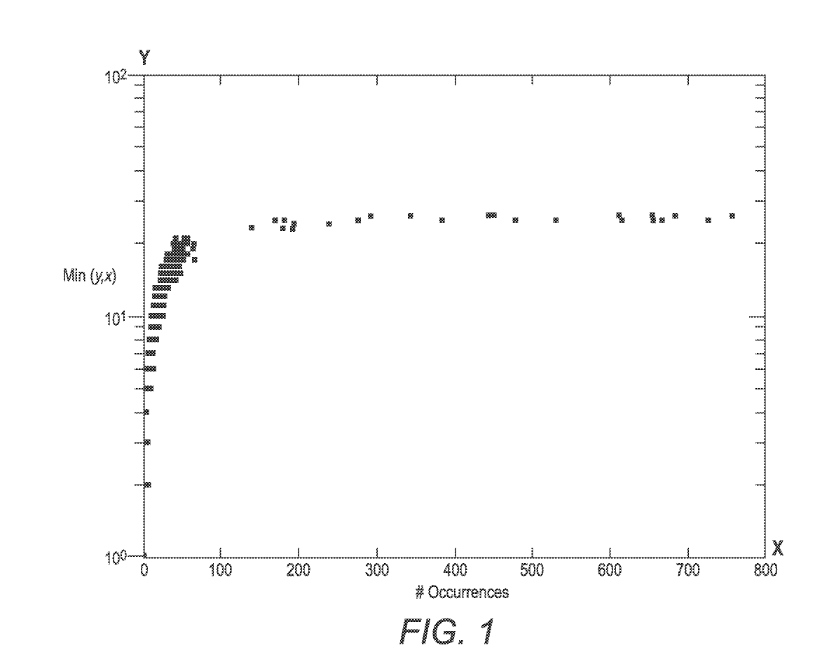

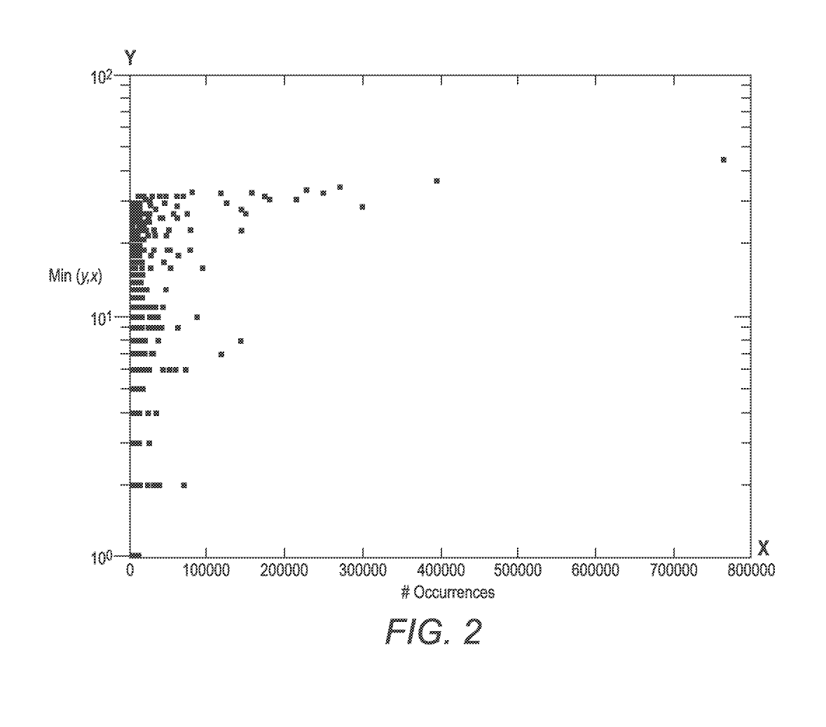

Using a context of length exactly 1 adds another limitation: the maximum size of the context is bounded by the alphabet size. This evident from FIGS. 1 and 2, where all maximal repeats are plotted, showing the number of occurrences versus the minimal value m such that the repeat is [symbol] m, m [symbol] -context diverse. The size of the context is upper-bounded by the size of the alphabet (26 in the case of the synthetic data in FIGS. 1 and 63 for the natural language case in FIG. 2). Two subsequences of completely different numbers of occurrence may have approximately the same number of different unitary contexts. This limits the possibility of discrimination of their potential interest as semantic units.

In an exemplary embodiment, the notion of context used in the bag-of-repeats representation of documents described, for example in application Ser. No. 13/901,736) is employed. However, instead of only considering a single symbol as the context for a subsequence co, the present method allows longer strings to be considered as the context, referred to herein as extended-context (∞-context). In one embodiment, the method considers all possible substrings v that start immediately to the right of a considered substring ω as potentially being a right context (respectively, end immediately to the left, as being a left context).

However, simply counting these contexts may not always be useful. In the case of the extended-right context, for example, if the counts of different substrings starting at the right are used, this would unduly favor words occurring at the beginning of the sequence. Since the underlying assumption is that repetition is a good indicator of importance, a first filtering would be to count only repeated substrings. Here again the notion of maximality is valuable. A straightforward approach of only counting repeats starting to the right of the occurrences would result in favoring words that end at the start of a long, repeated block of text, without considering the importance of this block of text.

To address these issues, the same notion of maximal repeat as defined above is employed. The definition is modified, however, by considering (in the case of extended-right-maximal context) only those repeat subsequences v that are right-maximal with respect to all occurrences of v that are immediately to the right of an occurrence of ω.

Specifically, a sequence v is added to the set of extended-right contexts of a given repeat ω if it a) occurs at least twice, and b) cannot be extended without losing support (number of occurrences).

Consider, for example, a word w which has exactly 4 occurrences in string s:

s= . . . ωbe . . . ωabc . . . ωabd . . . ωbf . . .

where a, b, c, d, e, f, are symbols and . . . represent more symbols from the alphabet.

If only a unit-length (unitary) context is taken into account, ω would have a right context of size 2 ({a, b}). With the extended-context definition, ω still has a right context of size 2, but they are different this time: ({b, ab}). In more detail, under the extended-context definition, the right contexts of ω to be considered include b, be, a, ab, abc, abd, bf (and other, longer sequences). Of these, only b, a, ab, occur twice, but a can be extended without losing support since ab also occurs twice, thus, a is filtered out of the set of extended right contexts of ω, leaving only b and ab as the right-maximal contexts of ω.

In one exemplary embodiment, the right and left-maximality with respect to a set I of occurrences of a substring v (as a context of ω) are defined as follows:

### Definition 1

v is right-maximal over I iff I⊂occₛ(v) and |{s[i+|v|]:i∈I}|≧2

i.e., a substring v which commences immediately to the right of a repeat subsequence ω is a right-maximal subsequence over the set I of occurrences of v occurring to the right of an occurrence of w if and only if:
a) the set I of occurrences of substring v is a subset of all occurrences of substring v, and
b) the number of different right contexts of v (strings starting position (i+number of symbols in v) over all positions i in set I) is at is at least 2.

### Definition 2

v is left-maximal over I iff⊂occₛ(v) and |{s[i−1]:i∈I}|≧2

i.e., a substring v which commences immediately to the left of a repeat subsequence ω is a left-maximal subsequence over the set of such occurrences of v if and only if
a) the set I of occurrences of substring v is a subset of all occurrences of substring v, and
b) the number of different left contexts of v (strings starting position (i−1) over all positions i in set I) is at is at least 2.

It may be noted that if a subsequence v is right-maximal over a subset I, then it is right-maximal over any superset I′⊃I (including I′=occ(v)).

Given these definitions for left- and right-maximal subsequences (contexts) v, the extended-context-diversity (∞-cd) of a repeat subsequence co can be defined as follows:

### Definition 3

The ∞-right-context of a maximal repeat ω is the set of right-maximal substrings v over I={i+|ω|:i∈occₛ(ω)}.

Here, maximal repeat co can be right-maximal or right, left maximal (both right- and left-maximal).
Equivalently, the co-left-context of a maximal repeat ω is the set of left-maximal substrings v over I={i−|v|:i∈occₛ(ω)}.

Here, maximal repeat co can be left-maximal or right, left maximal.

As with unitary-context-diverse repeats, the number of different left and right contexts can be specified:
A subsequence ω is x-∞-left-context-diverse (x-∞-lcd) in s if the number of different extended left contexts is at least x, i.e., ∞-lc(ω)≧x.
A subsequence ω is y-∞-right-context-diverse (y-∞-rcd) repeat in s if the number of different extended right contexts is at least y, i.e., ∞-rc(ω)≧y.
A subsequence ω is an [symbol] x, y [symbol] -∞-context diverse ( [symbol] x,y [symbol] -∞-lrcd) repeat in s if it is both x-∞-lcd and y-∞-rcd, i.e., if lc(ω)≧x and rc(ω)≧y.

With these definitions, in some cases, a subsequence ω can be an x-unitary right-context diverse repeat, but not an x-∞-right-context diverse one. Thus, the exemplary method may output counts and/or respective contexts for subsequences ω which are left and/or right-unitary context diverse repeats as well as for subsequences ω which are ∞-left- and/or right-context diverse repeats, depending on the type of information desired which these different classes of repeat can provide.

An advantage of the exemplary classes of ∞-context diverse repeats is that they are relatively few in number and simple to compute, while providing information on the sequence s that is often unavailable when a unitary context is used.

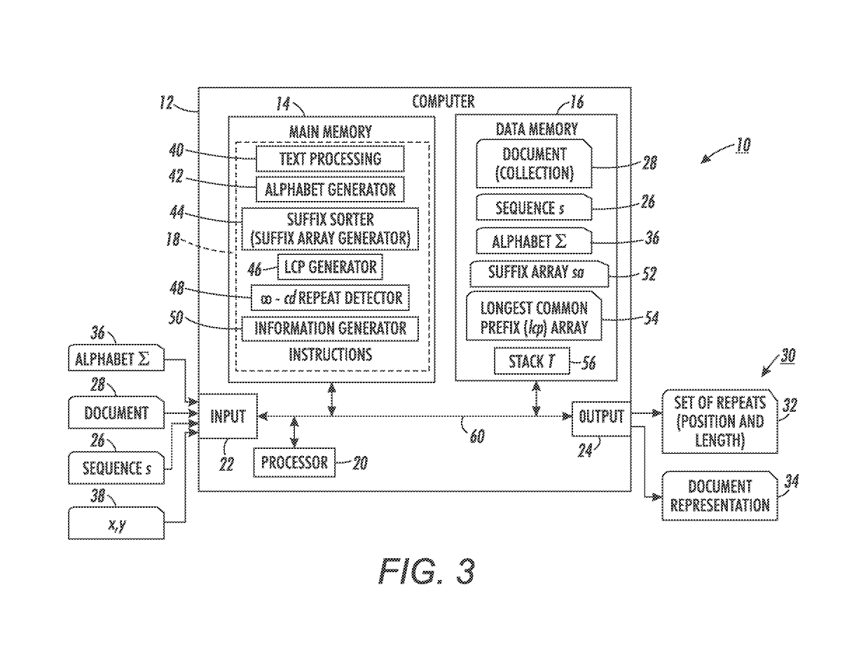

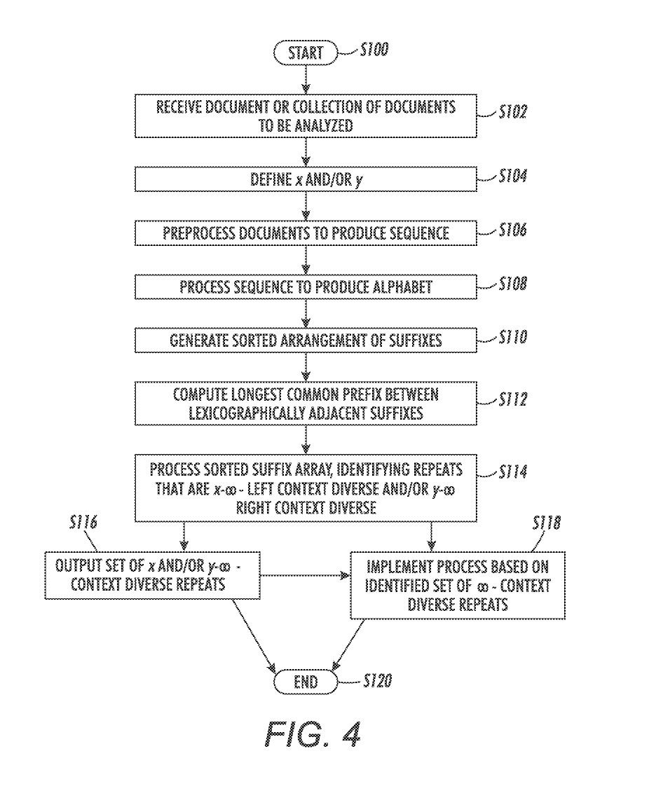

FIG. 3 illustrates an exemplary computer implemented system 10 for identifying ∞-cd repeats, for example, using Algorithm 1, described above. The system 10 includes a computer 12 with non-transitory main memory 14 and data memory 16. The memory 14 stores instructions 18 for performing the exemplary method described in FIG. 4. A digital processor 20, in addition to controlling operation of the computer 12, executes the instructions 18 stored in memory 14.

The illustrated computer 12 includes one or more input/output interfaces 22, 24 for communicating with external devices. Input interface 24, for example, may receive a sequence 26 of symbols (or a collection of sequences 26). In one embodiment, the sequence 26 may be generated from one or more text documents 28, such as one or books, journal articles, newspaper articles, webpages, OCRed forms, combinations thereof, or the like. The sequence(s) 26, e.g., one sequence per document, may be extracted externally or by the system 10. Two or more sequences may be concatenated to form a single sequence for a document collection. The symbols, in this case, can be words (optionally lemmatized), characters, or parts of speech (POS), as discussed above.

Output interface 24 outputs information 30, based on the application of instructions 18. The information output may include a set 32 of repeats generated by the system. In the exemplary embodiment, the set 32 of repeats consists of or includes an instance at least one type of ∞-cd repeat subsequence selected from: x-∞-lcd, y-∞-rcd, and [symbol] x,y [symbol] -∞-lrcd repeats, where x is the minimal value of left context diversity and y is the minimal value of right context diversity, as discussed above. In other embodiments, the information 30 includes a representation 34 of the document 28, which is based on the identified repeats. Other information 30 which is output may be based on the identified repeats. For example, a label may be output for a given document that is applied by a trained classifier based on the identified repeats in the document. In other embodiments, a cluster of documents is output or a set of documents similar to a selected document, or the like.

The input documents 28 or sequence(s) 26 generated therefrom may be accompanied by an predefined alphabet 36, or the alphabet may be constructed as the document(s) 28 is/are processed, and may be stored in memory 16. Provision may also be made for a user to input information 38 indicating selected values of x and y which specify the threshold number of different left and right contexts that an ∞-cd repeat must have to be included in the set 32. The user may be limited to a predefined range, such as selecting from 0-20 or from 0-10 for each of x and y. In the exemplary embodiment, at least one of x and y is at least 1. In some embodiments, at least one or both of x and y may be required to be at least 2. In some embodiments, at least one or both of x and y is at least 2 or at least 3 or at least 5. In some embodiments, y>x. In some embodiments, y is at least 2 x. In some embodiments, x+y>5. Suitable values of x and y may also depend on the likelihood that repeats in the selected class will be found. For example values of x and y may be based on the expected number of occurrences, giving, for example, those repeats whose context-size is at least one half their total number of occurrences. In one embodiment, suitable values of x and y are predetermined from training data, for example, values which tend to provide ∞-cd representations of documents that are useful for a particular processing task. The system returns repeat subsequences that satisfy the threshold(s) of left and/or right extended-context diversity ∞-cd, x and y, i.e., which can have the same number or a greater number of different contexts than the specified values. In one exemplary embodiment, no maximum is set on the number of different left and/or right contexts in which a given [symbol] x,y [symbol] -∞-lrcd repeat can be found, although this is not excluded.

In one embodiment, the software instructions 18 may include a text preprocessing component 40, an alphabet generator 42, an optional suffix sorter, such as a suffix array generator 44, an optional longest common prefix (lcp) generator 46, a repeat subsequence detector (repeat detector) 48, and an information generator 50. Briefly, the text preprocessing component 40 computes a sequence 26 of symbols in the alphabet 36, based on the input document(s) 28. Optionally, the text preprocessing component 40 may combine (by e.g., concatenation) sequences from documents 28 in a collection of two or more documents to create a larger sequence 26. Where a preexisting alphabet is not employed, the alphabet generator 42 generates and stores the alphabet 36, e.g., as the document in being processed by the text preprocessing component 40. The suffix array generator 44 generates a suffix array 52 (or other lexicographically-sorted arrangement of suffixes), from the sequence 26. The longest common prefix (lcp) generator 46 generates a longest common prefix array 54 to be used in combination with the suffix array 52 by the repeat detector 48 for detection of ∞-cd repeats. Information generator 50 generates and outputs information 30, based on the ∞-cd repeats computed by the repeat detector 48.

The text preprocessing component 40 parses the input document(s) 28 by employing a grammar or other processing technique. For example, the preprocessor 40 may identify words in the input document(s) and reduce all the words to a normalized form, such as a lemmatized, lowercase form, which may serve as the symbols. In this process, plural nouns are replaced by the singular form and verbs may be replaced by the infinitive form of the verb. Punctuation may be stripped from the sequence. In some embodiments, words may be processed to identify their part of speech, by part-of-speech (POS) tagging, and the POS tags serve as symbols. If an alphabet is not input or the same as used natively by system 10, the alphabet generator 42 may, before or after preprocessing, generate an alphabet 36 which includes all the symbols found within the document(s) 28.

One way of computing all ∞-cd repeats is a two stage approach in which all repeats occₛ(ω) are first computed and then, for each w all occurrences are inspected and those which meet the requirements of x and/or y are stored. However, this approach may be computationally expensive in some cases. Thus, the exemplary method uses a suffix tree or corresponding suffix array which enables ∞-cd repeats to be computed in linear time, for a given alphabet. In the exemplary system and method, the right (and/or left) context is computed using two arrays: a suffix array 52 and a longest common prefix (lcp) array 54. To save memory, the suffixes themselves need not be stored. Instead, the starting position of each suffix in the sequence is stored.

Data memory 16 stores the input document 28, sequence 26, and alphabet 36. Data memory also stores the suffix array 52 and longest common prefix (lcp) array 54 after they are created by the suffix array generator 44 and LCP generator 46, respectively (e.g., generated as described above). Data memory also stores a stack 56, such as a linked list, which is used by the ∞-cd repeat detector 48 to generate the set 32 of repeats. The stack 56 is a Last-In-First-Out (LIFO) data structure storing elements which can be added to the stack by a “push” operation and retrieved from the stack by a “pop” operation. The stack may also support a “top” operation (sometimes called “peak”) to access the topmost element without removing it from the stack. Data memory also stores various local variables used by the separate modules which are omitted for clarity.

The computer 12 may include one or more dedicated and/or general purpose computing devices, such a server computer or a desktop or laptop computer with an associated display device and a user input device, such as a keyboard and/or cursor control device (not shown), or any suitable computing device capable of implementing the method. The memories 14, 16 may be separate or combined and may represent any type of computer readable memory such as random access memory (RAM), read only memory (ROM), magnetic disk or tape, optical flash, flash memory, or holographic memory. In one embodiment, the memory 14, 16 comprises a combination of random access memory and read only memory, which in the exemplary embodiment are non-transitory devices. The digital processor 20 can be variously embodied, such as by a single-core processor, a dual-core processor (or more generally by a multiple-core-processor), a digital processor and cooperating math coprocessor, a digital controller, and the like.

Exemplary input and output interfaces 22, 24 include wired and wireless network interfaces, such as modems, or local interfaces, such as USB ports, disk drives, and the like. Hardware components 12, 14, 16, 22, and 24 of the computer are communicatively interconnected by a data/control bus 60.

The term “software” as used herein is intended to encompass any collection or set of instructions executable by a computer or other digital system so as to configure the computer or other digital system to perform the task that is the intent of the software. The term “software” as used herein is intended to encompass such instructions stored in the storage medium such as RAM, a hard disk, optical disk, or so forth, as is also intend to encompass so-called “firmware” that is software stored on a ROM or so forth. Such software may be organized in various ways, and may include software components organized as libraries, Internet-based programs stored on a remote server or so forth, source code, interpretive code, directly executable code, and so forth. It is contemplated that the software may invoke system-level code or calls to other software residing on a server or other location to perform certain functions.

FIG. 4 illustrates a method which may be performed with the system of FIG. 3. The method begins at S100.

At S102, a document 28 or collection of two or more documents 28 is received by the system 10 and stored in memory 16.

At S104, threshold values x and/or y for the minimum number of different left and/or right contexts of an ∞-cd repeat may be defined. In one embodiment, provision is made, e.g., through a graphical user interface, for a user to select values of x and/or y. The user may be provided with a range of values of x and/or y from which to choose. Alternatively, suitable values of x and/or y for a particular task may be learned, e.g., on a set of training documents.

At S106, the document(s) 28 may be processed by the text preprocessor 40 to produce the sequence 26 which is to be input into the suffix array generator 44. This may include OCR processing the document, if not in text format, lemmatizing words and/or identifying parts of speech, and inserting a special character § to delineate the end of each document.

At S108, the sequence 26 may be processed by the alphabet generator 42 to produce an alphabet Σ 36. The alphabet may consist of all symbols occurring in the sequence. The special characters §₁, §₂ are not members of alphabet Σ 30. Alternatively, alphabet Σ 30 may be predefined.

At S110, a sorted suffix array 52 is computed by the suffix array generator 44, based on the sequence 26.

At S112, an lcp array 54 is computed by the LCP generator 46 from the sorted suffix array.

At S114, the sequence 26, suffix array 52, and lcp array 52 are processed to produce a set of ∞-cd repeats 32, by the ∞-cd repeat detector 48, as explained with reference to Algorithm 1. In particular, the method includes visiting each internal node of a suffix array in sequence and for each internal node (corresponding to a repeat subsequence), visiting each of its descendant nodes to identify those that are also internal nodes. A counter is maintained so that at the end of this step, the number of descendant nodes which are internal nodes is computed and compared to the threshold y (or x in the case of a reverse sequence) to determine if it meets the threshold. If so, the considered internal node is identified as a y-∞-cd (or x-∞-cd) repeat. Repeats that are x,y-∞-cd may also or alternatively be identified. The repeat may be identified by reference to its position in a suffix array and length. While traversing the array, the length, in symbols, of a longest common prefix of a pair adjacent suffixes is used to determine the last occurrence of a given repeat, i.e., when a last descendant node for a given repeat has been processed.

At S116, based on the identified set of ∞-cd repeats 32, the repeats in the identified set occurring in at least one document in the collection may be identified and output by the information generator 50. Index positions and/or lengths of the identified ∞-cd repeats may be output.

At S118, a process may be implemented based on the identified ∞-cd repeats 32 for one or more of the documents in the collection and information 30 based on the process may be output.

The method ends at S120.

As will be appreciated, the term “suffix array” can be considered as equivalent to a prefix array in which the special character § is positioned at the beginning of the sequence, rather than the end and a longest common prefix (lcp) is equivalent to a longest common suffix (Ics) in this case. Alternatively, if the end of the sequence is considered as the beginning, the same result is achieved. The claims are intended to be understood as encompassing each of these embodiments.

### Identification of Extended Right (Left) Context Diverse Repeats

In the exemplary method, computing ∞-cd repeats entails simultaneously keeping track of the subsequence ω currently being analyzed, as well as of all repeats occurring as its context. However, there are several ways for simplifying this task. A first way is to consider the sequence as a suffix tree:
Let [symbol] be the suffix tree of sequence s. The ∞-right-context of a word co corresponds to all internal nodes of the subtree of [symbol] rooted by ω.

To see this, it may be noted that there is a node ω in the suffix tree [symbol] . This comes from the fact that ω is, by definition a maximal repeat, and the internal nodes of the suffix tree [symbol] are all right-maximal repeats of s. See, Dan Gusfield, “Algorithms on Strings, Trees, and Sequences: Computer Science and Computational Biology” Cambridge University Press (January 1997)). That a right-context v is right-maximal over the occurrences starting after an occurrence of ω is equivalent to saying that ω·v is right-maximal, which are exactly the internal nodes under co.

A “suffix,” as used herein, is a contiguous subsequence of one or more symbols in the sequence which terminate at the end of the sequence and which can include from 0 to all symbols in the sequence. A “prefix,” as used herein, is a contiguous subsequence of one or more symbols of the respective suffix, beginning with the first symbol in the suffix. The longest suffix is the length of the entire sequence, plus the termination character §₂, if used. The shortest suffix is the termination character §₂.

Each internal node (i.e., a node which is not a leaf) in the suffix tree corresponds to a subsequence ω. Looking at the descendants of ω, which correspond to sequences v, those that are also internal nodes correspond to ∞-rcd repeats. If there are two or more different descendant nodes of ω that are internal nodes, then ω is a ∞-right-maximal repeat. If there are x or more different descendant nodes of ω that are internal nodes, then ω is a y-∞-fight-context-diverse repeat. As will be appreciated, a prefix tree could be used for identifying x-∞-left-context-diverse repeats. Alternatively, a suffix tree can be created for the reverse sequence, i.e., starting at the end of the sequence and working backward. The x-∞-fight-context-diverse repeats identified for the reverse sequence then correspond to x-∞-left-context-diverse repeats for the original sequence.

As an alternative to using suffix trees to identify y-∞-rcd and/or x-∞-lcd repeats, a suffix array (or two suffix arrays, for the original and reverse sequences, respectively) may be used together with a corresponding longest common prefix (lcp) array, as described, for example, in application Ser. No. 13/901,736; Gallé et al., “On context-diverse repeats and their incremental computation,” Language and Automata Theory and Applications, pp. 384-395, Springer International Publishing (2014), hereinafter, “Gallé 2014”; and Puglisi, et al., “Fast optimal algorithms for computing all the repeats in a string,” Prague Stringology Conf., pp. 161-169 (2008)), and described in further detail below. A suffix array is part of the suffix-tree data structure family. It is composed of a lexicographically ordered array of all suffixes of the input sequence. Thus, the term “suffix tree” encompasses suffix arrays.

Algorithm 1, below, is an example of one method for computing extended right-context diverse (∞-rcd) repeats using a suffix array, being a more memory-efficient data structure than conventional suffix trees. Traversing the repeats using this data structure corresponds to basically traversing the suffix tree in a depth-first manner (the so-called lcp-interval tree) (see, Abouelhoda, et al., “Replacing suffix trees with enhanced suffix arrays. J. Discrete Algorithms, 2:53-86 (2004)).

In the exemplary algorithm, a stack is used to keep track of the repeats. Each element of the stack is a tuple which includes a starting position, length, and count of repeats. When a repeat is popped, these are then inherited by the topmost (head) repeat in the stack.

The size of a word's ∞-right-context can then be easily obtained by keeping a global counter of repeats that passed over the stack (variable counter in Algorithm 1). The suffix array is traversed when computing repeats with this data structure by pre-computing a longest common prefix array (the lcp array). An increase of the values in this array denotes a new repeat, a decrease denotes the end of a repeat, and equality just another occurrence of the current topmost repeat.

In a similar manner, co-left-maximal repeats (∞-lcd) can be computed equivalently using the suffix array of the reversed sequence s. As described in application Ser. No. 13/901,736 and Gallé 2014, it is possible to merge, in linear time, repeats computed over the sequence with another set of repeats coming from the reversed sequence.

Applying this same technique here yields the following theorem:
Given a sequence s, all [symbol] x, y [symbol] -∞-context-diverse repeats over s can be computed in [symbol] (|s|) time.

Because there may be a linear number of these repeats, this algorithm is optimal.

In Algorithm 1 below, which illustrates an exemplary method for computation of y-∞-rcd repeats, the following definitions apply:

As inputs, the value y is the minimum size of the right context diversity (minimum number of different right ∞-contexts for the repeat to be recognized) and the lcp array 54 is the precomputed longest common prefix array for the sequence (a description of how this can be created is provided in copending application Ser. No. 14/047,099). The output of the algorithm is the set of y-∞-rcd repeats. These may be output in the form of their suffix array positions and length of symbols.

j refers to the index position the lexicographically-sorted suffix array.

The variable T is a stack of tuples [symbol] p, l, c [symbol] , each representing a respective internal node in the suffix array. It provides push, pop, and top operations. The variable p is the index in the suffix array (the suffix array sa[p] holds the position in the string where the repeat is located), l is the length of the repeat, and c is a global counter indicating that this repeat is the c-th identified.

T.top( ).l is the length of the repeat at the top of the stack.

st is the position of a new repeat added to the stack.

counter is a variable counter which is incremented each time an internal node is identified.

stcounter stores a current value of the global counter.

The symbol = tests for the equivalence of the objects on the left and right sides. The symbol != tests for the lack of equivalence of the objects on the left and right sides.

The assignment operator := assigns the value on the right to the variable on the left.

Algorithm 1 Computation of extended right-context-diverse
(y-∞-rcd) repeats in [symbol] (|s|)

∞ - rcd(lcp, y)
Input: lcp-array, minimal value of right context diversity y
Output: (∞ - rcd) repeats in the form [symbol] position over suf fix array, length

[symbol]

| | |
|---|---|
| 1: | T = empty stack |
| 2: | [symbol] p, l, c [symbol] := [symbol] 0, 0, 0 [symbol] |
| 3: | T.push( [symbol] p, l, c [symbol] ) {ensures that the stack never becomes empty} |
| 4: | counter = 0 |
| 5: | for all j ∈ [2..n + 1] do |

| | |
|---|---|
| 6: | st := j − 1 |
| 7: | stcounter := counter |
| 8: | while T.top( ).l > lcp[j] do {last occurrence of a repeat} |

| | |
|---|---|
| 9: | [symbol] p, l, c [symbol] := T.pop( ) |
| 10: | st := p |
| 11: | stcounter := c |
| 12: | if counter − c ≧ y then |

| | |
|---|---|
| 13: | output [symbol] p, l [symbol] {has j − p occurrences} |

| | |
|---|---|
| 14: | end if |

| | |
|---|---|
| 15: | end while |
| 16: | if T.top( )l ! = lcp[j] {new repeat, which already has j − st |

occurrences}

| | |
|---|---|
| 17: | T:push( [symbol] st, lcp[j], stcounter [symbol] ) |
| 18: | counter := counter + 1 |

| | |
|---|---|
| 19: | end if |

| | |
|---|---|
| 20: | end for |

Briefly, the algorithm proceeds as follows. Conceptually, the method traverses a suffix tree (e.g., stored as a suffix array 52) looking at all possible internal nodes and checking their descendant nodes to see if any of them are also internal nodes. The suffix array arranges the nodes in lexicographic order, thus all substrings which start with the same prefix are arranged sequentially, allowing each one to be inspected in turn. For a given internal node (i.e., at an index j for which the subsequent index has an lcp of at least 1), the counter is incremented for each descendant which is also an internal node. When all the descendants have been inspected, the difference between the counter at the beginning and the counter at the end of checking the descendants gives the number of descendants which are right maximal, i.e., which are extended-right contexts.

At step 1, the stack starts as empty.

At step 2, the values of [symbol] p, l, c [symbol] are all set to 0.

At step 3, the first of the tuples in the suffix array is pushed onto the stack.

At step 4, the variable counter counter is set to 0.

At step 5, for each index j in the suffix array, the method proceeds as follows:

At step 6, st, the position of a potential new repeat added to the stack, is set to the preceding index j−1.

At step 7, a stack counter stcounter is set to the current value of the variable counter.

At step 8, while the length of the repeat at the top of the stack is greater than the length of the longest common prefix for suffix array index j, then the method iterates through steps 9-15, otherwise to step 16. When the length of the repeat is greater than the lcp, this means it is the last occurrence of a given repeat.

At step 9, [symbol] p, l, c [symbol] is set to the values of the top repeat popped out of the stack T.

At step 10, st, the position of a new repeat added to the stack, is set to p, the position in the sequence where the repeat starts.

At step 11, the stack counter is set to c (the global counter indicating that this repeat is the c-th identified).

At step 12, if the difference between the variable counter and the global counter c is y or greater, then the method proceeds to step 13, otherwise to step 14. In this way, the descendant nodes which have been visited in the sub-tree for node ω that are internal nodes are counted (counter-c) and if greater in number than the threshold y, the node ω is recognized as being a y-∞-rcd repeat.

At step 13, [symbol] p, 1 [symbol] is output, i.e., the position in the suffix array and length of the identified y-extended-right-context-diverse repeat.

At step 14, if the difference between the variable counter and the global counter c is less than y, the method returns to step 9.

At step 15, once T. top( ).l≦lcp[j], the method proceeds to step 16.

At step 16, if the length of the repeat at the top of the stack is not equal to (i.e., is smaller than) the length of the longest common prefix for suffix array index j, then this indicates a new repeat with j-st occurrences and the method proceeds to step 17. If T. top( ).l=lcp[j], this indicates just another occurrence of the current topmost repeat.

At step 17, the repeat corresponding to [symbol] st, lcp[j], stcounter [symbol] is pushed onto the stack and p receives the pushed value of st in the “pop” at line 9.

At step 18, the variable counter is incremented by 1 to indicate a new internal node has been found and the method proceeds to step 19.

At step 19, the method returns to step 6 for the next index in the array.

At step 20, the algorithm ends.

The same process can be used to identify x-∞-lcd repeats (e.g., using a suffix array generated starting from the end of the sequence). Optionally, a merged process can be used to identify set of [symbol] x, y [symbol] -∞-lrcd repeats. Merging the sets of x-∞-lcd and y-∞-rcd repeats can be performed, for example as described in copending application Ser. No. 14/047,099.

The repeats in the selected class, such as the set of [symbol] x,y [symbol] -∞-lrcd repeats, which satisfy the preselected values of x and/or y can be identified in a document (or in a document collection of two or more documents) and can be used to characterize the document (or any one or more of the documents in the collection). Representing a document based on the occurrence of these and optionally other types of repeats can be used for a variety of purposes, such as document clustering, similarity computation, document retrieval, and the like.

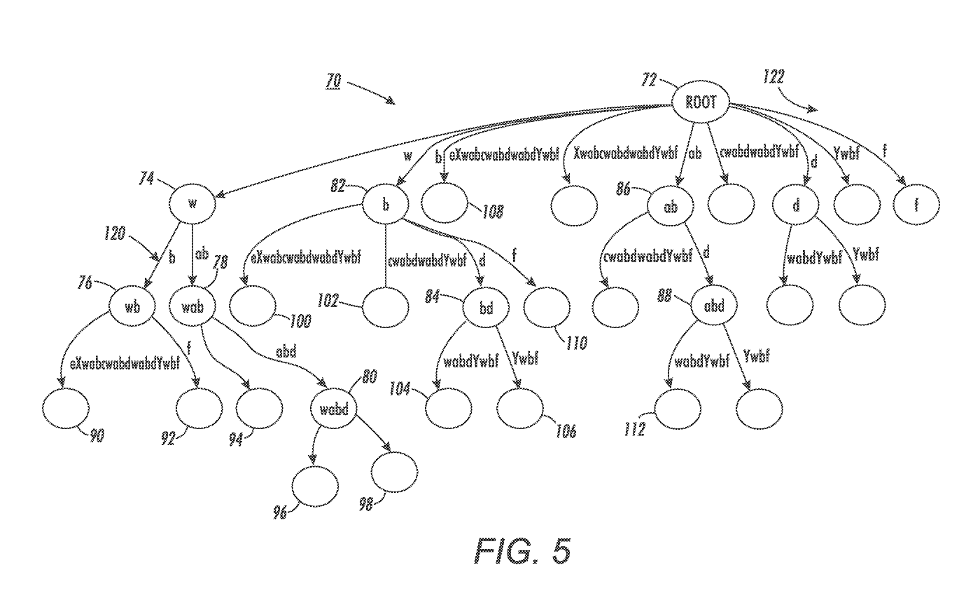

As an example of the exemplary algorithm, consider the suffix tree 70 shown in FIG. 5 for the sequence s=wbeXwabcwabdwabdYwbf. The suffix tree includes a root node 72, which denotes the entire sequence, and a set of internal nodes 74, 76, 78, 80, 82, 84, 86, 88, etc. and a set of leaf nodes 90, 92, 94, 96, 98, 100, 102, 104, 106, 108, 110, 112, etc. The internal nodes space other nodes from the root. Each internal node corresponds to a repeat subsequence in s and each leaf corresponds to a unique subsequence (only occurring once). Each node is connected directly or indirectly to the root via a respective path 120, 122, etc. Each internal node has at least two descendants and each path from the root terminates in a single leaf node. Leaf nodes thus have no descendants. The nodes each contain the concatenation of the subsequences of the edges from the path to it (the leaves are generally left blank for illustration purposes only). In the illustrated sequence s, the repeat substring w is denoted by an internal node 74 and has two extended right-contexts: {b,ab}, each forming a respective internal child node 76, 78. Nodes 76 and 78, representing the repeat subsequences wb, wab are also each an internal node, since each has two child nodes. Thus, an extended-context-diverse repeat is identified as being an internal node at least one of whose descendant nodes (including child nodes and further removed descendants) is/are also internal nodes (assuming that y≧1). It can be seen that node 82 represents a repeat b with a right-context of {d} (all other contexts occur only once), resulting in internal node 84. The same is true for ab (node 86).

The associated suffix array for this sequence is shown in TABLE 1. The first column j is the index position in the suffix array. In the predefined lexicographic order used for arranging the suffixes (which could of course be different), upper case letters are ordered before the lowercase ones, thus XwabcwabdwabdYwbf is the first suffix in the array (assigned index j=0) and abdYwbf is ordered before abdwabdYwbf. The second column, sa is the identifier of the suffix array position, i.e., the index of the starting position of the suffix in the sequence. The longest suffix is considered to be the entire length of the sequence, and has an sa of 0. As will be appreciated, the numbering of the positions in the sequence is consecutive and could alternatively start with 1). The lcp array gives the length of the longest common prefix between two suffixes whose starting positions are adjacent in the suffix array, meaning the suffixes are lexicographically consecutive. The longest common prefix is identified by counting matching symbols starting from the first symbol of the two suffixes until the two symbols being compared do not match, i.e., extending potentially to the last symbol of one of the suffixes. The length of the longest common prefix is indicated in column lcp[j], in the row corresponding to the second of the two suffixes For example, for the suffix abdwabdYwbf, the next (previous) consecutive suffix in the lexicographically ordered suffix array is abdYwbf. The first three letters abd forming the prefix of these two suffixes is the same. Thus the longest common prefix is length 3, which is inserted in the lcp column at index 4. Because there is no row preceding row 0, lcp[0] is defined as 0.

As will be appreciated, the suffix array sa and lcp array may be stored as separate arrays 52, 54. This example also ignores the unique character §₂, occurring at the last position in the sequence, which would normally be used as the first (here 0) index in the lexicographic sorting order.

TABLE 1

| j | sa | lcp[j] | s[sa[j] . . .] |
|---|---|---|---|
| 0 | 3 | 0 | XwabcwabdwabdYwbf |
| 1 | 16 | 0 | Ywbf |
| 2 | 5 | 0 | abcwabdwabdYwbf |
| 3 | 13 | 2 | abdYwbf |
| 4 | 9 | 3 | abdwabdYwbf |
| 5 | 6 | 0 | bcwabdwabdYwbf |
| 6 | 14 | 1 | bdYwbf |
| 7 | 10 | 2 | bdwabdYwbf |
| 8 | 1 | 1 | beXwabcwabdwabdYwbf |
| 9 | 18 | 1 | bf |
| 10 | 7 | 0 | cwabdwabdYwbf |
| 11 | 15 | 0 | dYwbf |
| 12 | 11 | 1 | dwabdYwbf |
| 13 | 2 | 0 | eXwabcwabdwabdYwbf |
| 14 | 19 | 0 | f |
| 15 | 4 | 0 | wabcwabdwabdYwbf |
| 16 | 12 | 3 | wabdYwbf |
| 17 | 8 | 4 | wabdwabdYwbf |
| 18 | 0 | 1 | wbeXwabcwabdwabdYwbf |
| 19 | 17 | 2 | wbf |
| 20 | 20 | 0 | |

From the foregoing, it is evident that, after lexicographical sorting, a shorter repeat may be followed by a longer repeat, which may in turn be followed again by another occurrence of the shorter repeat.

During execution of the algorithm, when j=16, “wab” gets pushed on the stack (lcp[j]=3) and in the next iteration (j=17) the same happens to “wabd”. Because in the next iteration lcp[j]=1, both of these get popped out, but the counter is incremented twice which then gives the right-context size when the repeat “w” is popped out at j=20.

While particular reference has been made herein to letters as symbols, it is to be appreciated that words may be considered as the symbols of the sequence s. In some embodiments, the sequences or documents may be stripped of punctuation (or punctuation simply ignored). The input may also be other than words or documents. The input may be, for example, a gene or integer sequence.

### Example Processing Operations (S118)

1. Generating a Vector Spaced Representation of a Document in the Collection

Each document dᵢ in the collection of documents d₁, d₂ . . . d_{N} may be mapped into a vector r_{di} of size K, where, r_{di}(j) contains the number of times an [symbol] x, y [symbol] -LRCD repeat rⱼ appears in document dᵢ. The exemplary representation 34 thus formed uses the occurrence and/or position of the [symbol] x, y [symbol] -∞-lrcd repeats in that document, which have been identified for the collection as a whole as S116, as a basic feature in the generated vector space representation.

In one embodiment, the document representation includes a vectorial representation which is indexed by the [symbol] x, y [symbol] -∞-lrcd repeats identified in the set. For each index, a value for one of the repeats that are in the class of [symbol] x, y [symbol] -∞-lrcd repeats represents the number of occurrences of that repeat in the document. The repeat may be identified as present in the document, even if the contexts are different from those employed in identifying the repeat as an [symbol] x, y [symbol] -∞-lrcd repeat. As will be appreciated, the [symbol] x, y [symbol] -∞-lrcd repeat may be identified in a document even if the repeat does not occur more than once in that document and does not satisfy the values of x and y within the document itself.

In some embodiments, the vectorial representation may be normalized, for example so that all values sum to 1, or so that the sum of their square roots is 1.

The vectorial representation may be relatively sparse, depending on the length of the document and the size of the collection.

2. Classifier Learning and Classification

Documents may be classified based on their vectorial representation of repeats using a trained classifier. Classifier learning can be performed with any suitable non-linear or linear learning method. Such classifier systems are well known and can be based, for example, on a variety of training algorithms, such as, for example: linear discriminants such as linear least squares, Fisher linear discriminant or Support Vector Machines (SVM); decision trees; K-nearest neighbors (KNN); neural networks, including multi-layer perceptrons (MLP) and radial basis function (RBF) networks; and probabilistic generative models based e.g., on mixtures (typically Gaussian mixtures). An exemplary classifier may include a multiclass classifier or a set of binary classifiers, each trained on a respective one of the categories (labels) in a set. Training data includes labeled documents and their respective vectorial representations, generated in the same manner. In the exemplary embodiment, the training data may form a part of the document in the collection.

In one exemplary embodiment, Support Vector Machines (SVMs) can be used for multi-class training data. Exemplary SVM algorithms and the mapping convergence methods are discussed in Chidlovskii, et al., U.S. Pub. No. 2011/0103682, incorporated herein by reference.

3. Clustering/Generating Most Probable Words in Collection of Documents

The exemplary repeat-based representations 34 can be as an input in a probabilistic topic (clustering) model. In one embodiment, the exemplary [symbol] x, y [symbol] -∞-lrcd repeats are used as input features in a clustering component, such as a Latent Dirichlet Allocation (LDA) model. In another embodiment, only right and left-context unique occurrences of repeats are used in the clustering model. The output of such a model may be a set of the most probable repeats for each of a set of topics. See, for example, Blei, et al., and U.S. application Ser. No. 13/437,079, filed Apr. 4, 2012, entitled FULL AND SEMI-BATCH CLUSTERING, by Matthias Galle and Jean-Michel Renders, the disclosures of which are incorporated herein by reference, for details on exemplary clustering algorithms which can be used with text documents.

4. Similarity Between Documents

The similarity between two repeats-based feature vectors 34 representing two documents can then be defined as their negative L1 or L2 distance. In one embodiment, a simple dot product or cosine similarity between vectors can be used as the similarity measure between two documents.

As will be appreciated the uses of the exemplary repeats-based representation 34 are not limited to those mentioned herein.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart method shown in FIG. 4, can be used to implement the method described herein.

The method illustrated in FIG. 4 may be implemented in a computer program product or products that may be executed on a computer. The computer program product may include a non-transitory computer-readable recoding medium on which a control program is recorded, such as a disk, hard drive, or the like configured for performing the method. Common forms of computer-readable media include, for example, floppy discs, flexible discs, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 12, (for example, an internal hard drive of RAM), or may be separate (for example, an external hard drive operatively connected with the computer 12), or may be separate and accessed via a digital data network such as a local area network (LAN) or the Internet (for example, as a redundant array of inexpensive of independent disks (RAID) or other network server storage that is indirectly accessed by the computer 12, via a digital network).

Alternatively, the method may be implemented in transitory media as a transmittable carrier wave in which the control program is embodied as a data signal using transmission media, such as acoustic or light waves, such as those generated during radio wave and infrared communications, and the like.

Most grammatical inference algorithms approach the problem of constructing grammatical rules by separating the problem into two tasks: the first task focuses on how to select the constituent parts of the grammar (the spans of what will become the non-terminals of the grammar) and the second task focuses on how to relate these constituent parts to each other. This separation can be found in state-of-the-art practical inference algorithms, like ADIOS and ABL. The present system provides a more flexible approach which permits spans of varying lengths with varying context lengths and provides a computationally inexpensive algorithm to compute them.

Without intending to limit the scope of the exemplary embodiment, the following example illustrates the applicability of the method.

### Example

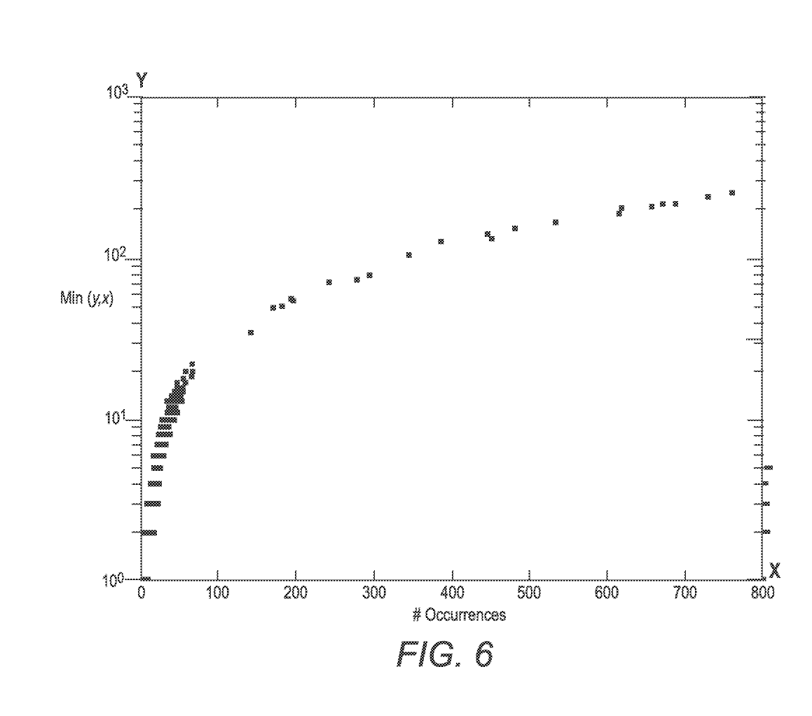

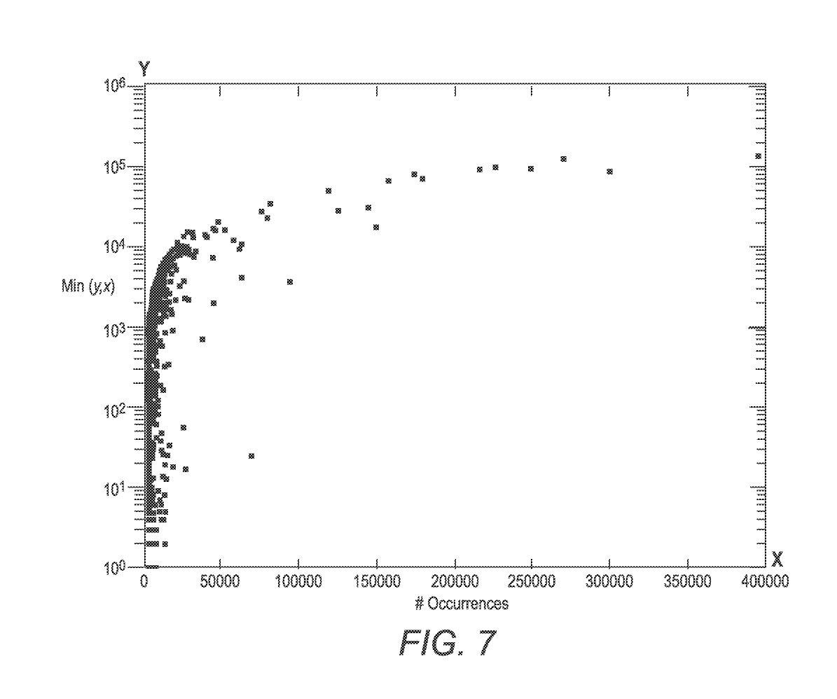

Algorithm 1 was implemented and ∞-context-diverse repeats were computed over the same two sequences as used in FIGS. 1 and 2. The corresponding plots are shown in FIGS. 6 and 7. FIG. 6 is for the uniform IID generated sequence of length 104 over an alphabet of 26 symbols and FIG. 7, for the King James Version of the Bible (using characters as symbols). In both FIGS. 6 and 7, a dot at (X,Y) corresponds to a maximal repeat with X occurrences and a minimum of Y different ∞-right and ∞-left contexts.

As can be seen, the linearity with respect to the number of occurrences (seen as a logarithmic curve in the figures due to the scale of the Y-axis) is not interrupted, making it easier to detect outliers on this curve which may be of potential interest as constituents.

The examples illustrate that the method is not only feasible, but computationally tractable despite the combinatorial nature of the problem.

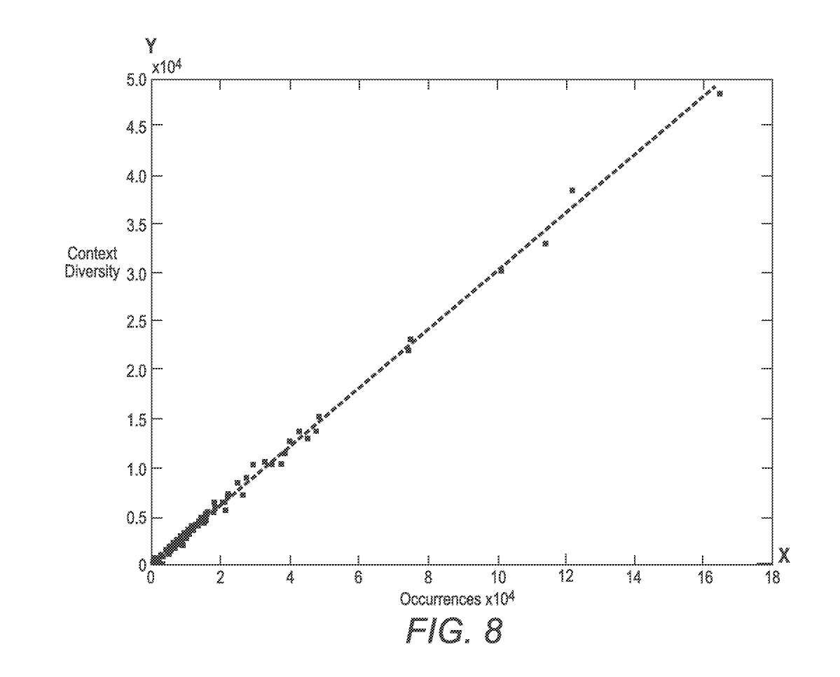

In some cases, the general trend is for the number of different contexts to perform linearly with respect to the number of occurrences, when a linear plot, as shown in FIG. 8, is generated. This allows detection of those constituents that diverge the most from the trend. For this example, the Penntree Bank corpus (a collection of parsed English sentences) was used for generating the sequence. In the Penntree Bank corpus, each sentence is annotated with parentheses which denote the phrase-structure of the sentence (how the underlying constituent grammar generated it). The sentences were also part of speech (POS) tagged with 36 different POS-tags. Parentheses spanning single words and whole sentences were filtered out, leaving 697,080 constituents, corresponding to 325,069 different strings. Of these, only 17% are repeated substrings but they make up 61% of the total constituents.

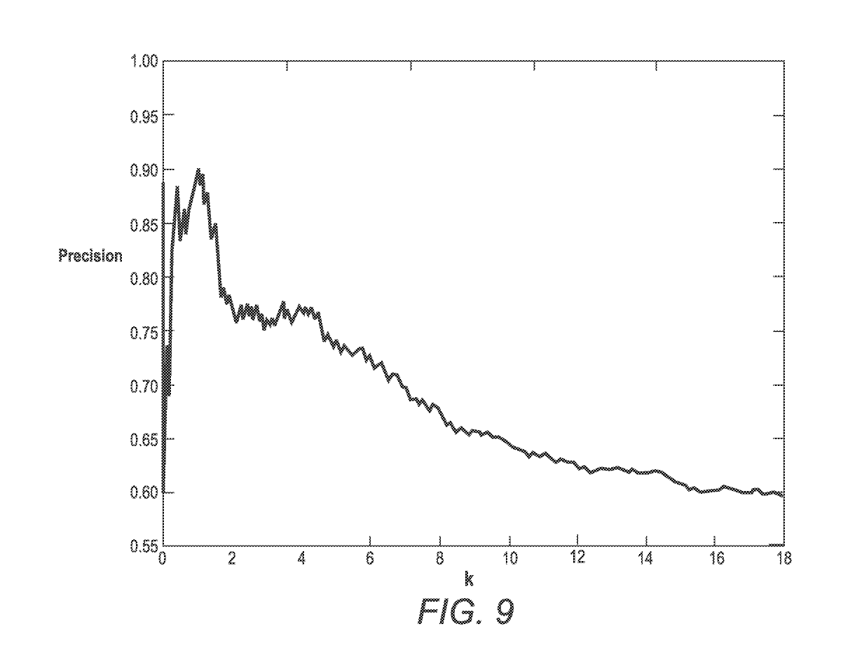

For this example, a line (using Matlab's polyfit function) is fitted to the results on this dataset (plotted on a linear scale) and then all extended context diverse repeats are ranked by their distance with respect to the line (the top ranked repeat is the one that is the most distant to the top of the line). Using this rank, the precision at rank k for the top repeats in the ranking, given by distance to the fitted curve in FIG. 8 (Prec@k), is computed. The results for the first 1000 repeats are shown in FIG. 9. As can be appreciated the highest ranked repeats are, in most cases, actual constituents, corresponding, for example to noun phrases, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method comprising:
receiving a sequence of symbols, the symbols being drawn from an alphabet;
with a processor, providing for identifying repeat subsequences of the symbols in the sequence, each of the identified repeat subsequences being a repeat subsequence which is at least one of left-maximal and right-maximal in the sequence, each identified repeat subsequence having at least one of:
at least one different right context in the sequence, each of the at least one different right contexts comprising a respective different subsequence of the symbols in the sequence which immediately follows an occurrence of the repeat subsequence in the sequence, each of the different right contexts being a right-maximal repeat with respect only to subsequences of the symbols that immediately follow an occurrence of the respective repeat subsequence, and
at least one different left context in the sequence, each of the at least one different left contexts comprising a respective different subsequence of the symbols in the sequence which immediately precedes an occurrence of the repeat subsequence in the sequence, each of the different left contexts being a left-maximal repeat with respect only to subsequences of the symbols that immediately precede an occurrence of the respective repeat subsequence; and
outputting at least one of:
at least one of the identified repeat subsequences as an extended-context-diverse repeat subsequence, and
information based on the identified extended-context-diverse repeat subsequences of symbols.

2. The method of claim 1, wherein the identifying of extended-context-diverse repeat subsequences of symbols in the sequence comprises:
generating a lexicographically-sorted arrangement of suffixes occurring in the sequence, each suffix comprising a sequence of the symbols;
based on the lexicographically-sorted arrangement of suffixes, identifying repeat subsequences which are internal nodes and that have descendants which are internal nodes; and
identifying extended-context-diverse repeat subsequences from the identified repeat subsequences.

3. The method of claim 2, wherein the identifying of extended-context-diverse repeat subsequences comprises:
computing, for adjacent pairs of suffixes in the lexicographically-sorted arrangement of suffixes, a length, in symbols, of a longest common prefix of the adjacent suffixes; and
traversing the lexicographically-ordered arrangement of suffixes, the length of the longest common prefix of a respective pair of suffixes being compared with a length of a current repeat subsequence and identifying a last occurrence of the current repeat subsequence, based on the comparison.

4. The method of claim 3, wherein the identifying of extended-context-diverse repeat subsequences comprises tracking each repeat subsequence with a tuple data structure [symbol] p, l, c [symbol] , where p represents an index in the suffix array which holds a position in the sequence where the repeat sequence is located, l represents the length of the repeat subsequence, and c is a global counter indicating that the respective repeat subsequence is the c-th identified.

5. The method of claim 1, wherein the generating of the lexicographically-sorted arrangement of suffixes occurring in the sequence comprises generating a first lexicographically-sorted arrangement of suffixes starting from a first end of the sequence and generating a second lexicographically-sorted arrangement of suffixes starting from a second end of the sequence, and
based on the first lexicographically-sorted arrangement of suffixes, identifying extended-right-context-diverse repeat subsequences from the identified repeat subsequences; and
based on the second lexicographically-sorted arrangement of suffixes, identifying extended-left-context-diverse repeat subsequences from the identified repeat subsequences.

6. The method of claim 5, further comprising identifying extended-right,left-context-diverse repeat subsequences from the identified repeat subsequences which are both extended-right-context-diverse repeat subsequences and extended-left-context-diverse repeat subsequences.

7. The method of claim 1, wherein the method further comprises defining at least one of a threshold value of different left contexts for a given repeat subsequence in the sequence and a threshold value of different right contexts for a given repeat subsequence in the sequence to be identified as an extended-context-diverse repeat subsequence.

8. The method of claim 7, wherein at least one of the threshold values is at least 2.

9. The method of claim 7, wherein the threshold values are different.

10. The method of claim 1, wherein the identifying of extended-context-diverse repeat subsequences comprises identifying maximal repeats in the sequence having both a threshold value of different left contexts in the sequence and a threshold value of different right contexts in the sequence.

11. The method of claim 1, wherein the symbols correspond to at least one of the group consisting of:
single characters of an alphabet that includes letters;
words in at least one document in a natural language; and
parts-of-speech assigned to words of at least one document in a natural language.

12. The method of claim 1, wherein the sequence is constructed from a collection of at least two documents.

13. The method of claim 1, wherein the method further comprises generating a representation of at least one document in a collection of documents from which the sequence is extracted based on occurrences of the identified extended-context-diverse repeat subsequences in the document and wherein the output information comprises the representation.

14. A computer program product comprising non-transitory storage medium storing instructions, which when executed by a processor, perform the method according to claim 1.

15. A system comprising memory which stores instructions for performing the method of claim 1 and a computer processor, in communication with the memory, which performs the method.

16. A system for identifying extended-context-diverse repeat subsequences comprising:
a suffix sorter which generates at least one lexicographically-sorted arrangement of suffixes from an input sequence of symbols, each of the at least one arrangement of suffixes representing a suffix tree in which a root representing the input sequence is connected to nodes representing subsequences of the input sequence, some of the nodes being internal nodes which space others of the nodes from the root;
a repeat subsequence detector which:
receives the arrangement of suffixes;
receives at least one of a threshold value for different left contexts for a given repeat subsequence in the sequence and a threshold value for different right contexts for a given repeat subsequence in the sequence;
identifies repeat subsequences in the sequence based on the at least one arrangement of suffixes, each of the identified repeat subsequences corresponding to an internal node in the suffix tree which has at least one descendant that is also an internal node;
for each identified repeat subsequence, compares a count of the descendants that are internal nodes with the at least one of the threshold values, and
identifies, as extended-context-diverse repeat subsequences, identified repeat subsequences for which the count of the descendants that are internal nodes meets the at least one of the threshold values;
a processor which implements the suffix sorter and the repeat subsequence detector.

17. The system of claim 16, further comprising a longest common prefix generator which computes, for adjacent pairs of suffixes in the lexicographically-sorted arrangement of suffixes, a length, in symbols, of a longest common prefix of the adjacent suffixes; and
wherein the extended-context-diverse repeat subsequence detector traverses the lexicographically-ordered arrangement of suffixes, using the length of the longest common prefix of a respective pair of suffixes to identify a last occurrence of a given repeat subsequence.

18. The system of claim 16, further comprising a text preprocessing component which generates the input sequence of symbols from a document collection.

19. The system of claim 16, further comprising a user interface for inputting a selection of the at least one threshold value.

20. A method for representing a document comprising:
receiving a collection of documents;
generating a sequence of symbols in an alphabet based on text of at least some of the documents in the collection;
defining a threshold value for at least one of:
different right contexts for a given repeat subsequence in the sequence, each of the different right contexts comprising a respective different subsequence of the symbols in the sequence which immediately follows an occurrence of the repeat subsequence in the sequence, each of the different right contexts being a right-maximal repeat with respect only to subsequences of the symbols that immediately follow an occurrence of the respective repeat subsequence, and
different left contexts for a given repeat subsequence in the sequence, each of the different left contexts comprising a respective different subsequence of the symbols in the sequence which immediately precedes an occurrence of the repeat subsequence in the sequence, each of the different left contexts being a left-maximal repeat with respect only to subsequences of the symbols that immediately precede an occurrence of the respective repeat subsequence;
processing the sequence to identify repeat subsequences, each comprising at least one of the symbols, and identifying those of the repeat subsequences in the sequence which have at least one of the threshold value of different left contexts and the threshold value of different right contexts as extended-context-diverse repeat subsequences; and
for a document in the collection, representing the document based on occurrences of repeat subsequences in the document that are among the identified extended-context-diverse repeat subsequences,
wherein at least one of the generating, defining, processing, and
representing is performed by a computer processor.
